(19) United States
(12) Patent Application Publication
(10) Pub. No.: US 2008/0055786 A1
(43) Pub. Date: Mar. 6, 2008

(54) Tunnel type magnetic sensor having protective layer formed from Pt or Ru on free magnetic layer, and method for manufacturing the same

(75) Inventors: Ryo Nakabayshi, Niigata-ken (JP); Kazumasa Nishimura, Niigata-ken (JP); Yosuke Ide, Niigata-ken (JP); Masahiko Ishizone, Niigata-ken (JP); Masamichi Saito, Niigata-ken (JP); Naoya Hasegawa, Niigata-ken (JP)

Correspondence Address: BRINKS HOFER GILSON & LIONE, P.O. BOX 10395, CHICAGO, IL, 60610, US

(73) Assignee: ALPS ELECTRIC CO., LTD.

(21) Appl. No.: 11/888,738

(22) Filed: Aug. 2, 2007

(30) Foreign Application Priority Data
Aug. 30, 2006 (JP) 2006-234472

(51) Int. Cl. G11B 5/127; G11B 5/33

(52) U.S. Cl. 360/316

(57) ABSTRACT

A tunnel type magnetic sensor includes a fixed magnetic layer that has magnetization fixed in one direction, an insulating barrier layer, and a free magnetic layer that has magnetization varied by an external magnetic field, which are laminated in that order from the bottom. The insulating barrier layer is formed from titanium oxide, and on the free magnetic layer, a first protective layer of platinum or ruthenium is formed. Accordingly, compared to the structure in which the first protective layer is not formed or the first protective layer is formed from Al, Ti, Cu, or IrMn, while a high rate of change in resistance is maintained, the magnetostriction of the free magnetic layer can be effectively decreased. When the insulating barrier layer is formed from aluminum oxide, the rate of change in resistance is decreased, or the magnetostriction of the free magnetic layer cannot be effectively decreased.

### CLAIM OF PRIORITY

This application claims benefit of the Japanese Patent Application No. 2006-234472, filed Aug. 30, 2006, which is hereby incorporated by reference.

### BACKGROUND OF THE INVENTION

1. Field of the Invention

The present invention relates to magnetic sensors using a tunnel effect, which are mounted, for example, in magnetic reproduction devices of hard disk apparatuses and in other magnetic detection devices, and more particularly, relates to a tunnel type magnetic sensor and a method for manufacturing the same, the tunnel type magnetic sensor particularly having a low magnetostriction λ of a free magnetic layer, superior stability of a reproduction head, and superior detection sensitivity.

2. Description of the Related Art

A tunnel type magnetic sensor (tunnel type magnetoresistive sensor) generates the change in resistance using a tunnel effect, in which when the magnetization of a fixed magnetic layer and that of a free magnetic layer are untiparallel to each other, since a tunnel current is unlikely to flow via an insulating barrier layer (tunnel barrier layer) provided between the fixed magnetic layer and the free magnetic layer, the resistance is increased to a maximum value, and in which when the magnetization of the fixed magnetic layer and that of the free magnetic layer are parallel to each other, since the tunnel current is most likely to flow, the resistance is decreased to a minimum value.

By using the principle described above, when the magnetization of the free magnetic layer varies by influence of an external magnetic field, this variation in electrical resistance is grasped as the change in voltage, and as a result, a leak magnetic field from a recording medium can be detected.

In Japanese Unexamined Patent Application Publication No. 11-161919, a tunnel type magnetic sensor including a fixed magnetic layer and a free magnetic layer, each having a multilayer structure, has been disclosed.

In Japanese Unexamined Patent Application Publication No. 2006-5356, a tunnel type magnetic sensor has been disclosed in which aluminum oxide (Al—O) is used for an insulating barrier layer, and a protective layer is formed of an inter-diffusion barrier layer, an oxygen adsorbing layer, and an upper metal layer provided in that order from a free magnetic layer side.

In Japanese Unexamined Patent Application Publication No. 2000-228003, a spin valve type magnetic sensor and a tunnel type magnetic sensor, each of which has a protective layer of a multi-film structure composed of ruthenium (Ru) and tantalum (Ta), have been disclosed.

In a magnetoresistive sensor disclosed in Japanese Unexamined Patent Application Publication No. 2005-109378, a protective layer is formed from Ta and Ru, and at an interface with a free magnetic layer, a spin filter layer is formed from platinum (Pt), Ru, or the like.

As one subject of the tunnel type magnetic sensor, a decrease in magnetostriction λ (absolute value) and an improvement in stability of a reproduction head may be mentioned. In addition, there may also be mentioned an increase in detection sensitivity by obtaining a high rate of change in resistance (ΔR/R) and an improvement in properties of the reproduction head.

In the tunnel type magnetic sensor disclosed in Japanese Unexamined Patent Application Publication No. 11-161919, the free magnetic layer is composed of two NiFe layers, the compositions of which being individually selected, and at an interface with the insulating barrier layer, Co or CoFe is provided; hence, as a result, the magnetostriction λ of the free magnetic layer is decreased.

As described above, in the related tunnel type magnetic sensors, by adjusting the composition and the film thickness of the free magnetic layer, in particular, of an enhancing layer which is in contact with the insulating barrier layer, the magnetostriction λ of the free magnetic layer is decreased.

However, in order to significantly decrease the magnetostriction λ of the free magnetic layer to a value as close as possible to zero, when the composition and the film thickness of the enhancing layer and/or a soft magnetic layer which is in contact therewith are changed, for example, the rate of change in resistance (ΔR/R) is decreased, and as a result, a reproduction head having superior properties cannot be obtained. Accordingly, it has been desired that while a high rate of change in resistance (ΔR/R) is maintained, the magnetostriction X of the free magnetic layer is decreased.

As a method for decreasing the magnetostriction λ of the free magnetic layer while the composition of the free layer is not changed, for example, in the tunnel type magnetic sensor disclosed in Japanese Unexamined Patent Application Publication No. 2006-5356, the protective layer is formed of the inter-diffusion barrier layer (ruthenium (Ru)), the oxygen adsorbing layer (tantalum (Ta)), and the upper metal layer (Ru) provided in that order from the free magnetic layer side. However, the decrease in magnetostriction λ is not satisfactory.

In addition, in the tunnel type magnetic sensors disclosed in Japanese Unexamined Patent Application Publication Nos. 11-161919 and 2006-5356, the insulating barrier layer is formed from Al—O, and as for a tunnel type magnetic sensor in which the insulating barrier layer is formed from Ti—O, the effect of decreasing the magnetostriction λ has not been known.

According to the magnetoresistive sensor disclosed in Japanese Unexamined Patent Application Publication No. 2000-228003, it has been disclosed that when the protective layer is formed from a plurality of films, since diffusion of a component element of the protective layer to the free magnetic layer caused by ion milling is suppressed, milling removal of the free magnetic layer can be reduced. As the protective layer having a multi-film structure, it has been disclosed that, for example, the two layers composed of Ru and Ta are provided in that order from the free magnetic layer side; however, the magnetostriction is not described. In addition, although it has been disclosed that the magnetoresistive sensor may include a tunnel type magnetic sensor, a concrete example is not described.

In addition, in the magnetoresistive sensor disclosed in Japanese Unexamined Patent Application Publication No. 2005-109378, the protective layer is formed from Ta and Ru, the spin filter layer is formed from Pt, Ru, or the like at the interface with the free magnetic layer, and thereby a high rate of change in resistance (ΔR/R) is obtained; however, the magnetostriction is not described.

As described above, when the protective layer of the magnetoresistive sensor is formed from a plurality of layers composed of Ta and Ru, the milling removal of the free magnetic layer can be reduced, and/or the rate of change in resistance (AR/R) can be increased; however, the increase and decrease in magnetostriction is not known. In particular, the magnetostriction and the rate of change in resistance (ΔR/R) of the tunnel type magnetic sensor having an insulating barrier layer composed of Ti—O are not described at all.

### SUMMARY OF THE INVENTION

Accordingly, the present invention has been conceived in order to solve the problems described above and provides a tunnel type magnetic sensor and a method for manufacturing the same, the tunnel type magnetic sensor being in particular capable of increasing the rate of change in resistance (ΔR/R) as high as possible and of decreasing the magnetostriction λ of the free magnetic layer, as compared to those obtained in the past.

The tunnel type magnetic sensor according to one embodiment comprises a fixed magnetic layer in which the magnetization direction is fixed in one direction; an insulating barrier layer; and a free magnetic layer in which the magnetization direction is varied by an external magnetic field, the layers being laminated to each other in that order from the bottom. In this tunnel type magnetic sensor, the insulating barrier layer is formed from titanium oxide (Ti—O), and on the free magnetic layer, a first protective layer formed from one of platinum (Pt) and ruthenium (Ru) is formed.

Accordingly, while a high rate of change in resistance (ΔR/R) is maintained as in the past, the magnetostriction λ of the free magnetic layer can be significantly decreased as compared to that obtained in the past.

According to one embodiment, counter diffusion of constituent elements occurs at the interface between the first protective layer and the free magnetic layer, and as a result, a concentration gradient is formed in which the platinum concentration or the ruthenium concentration is gradually decreased from the inside of the first protective layer in a direction toward the interface of the free magnetic layer with the insulating barrier layer.

In addition, since oxidation protection and the like for the free magnetic layer can be facilitated, a second protective layer composed of tantalum (Ta) is preferably formed on the first protective layer. In this case, counter diffusion of constituent elements occurs at the interface between the first protective layer and the second protective layer, and as a result, a concentration gradient is formed in which the platinum concentration or the ruthenium concentration is gradually decreased from the inside of the first protective layer in a direction toward an upper surface of the second protective layer.

In addition, the first protective layer preferably has a film thickness smaller than that of the second protective layer.

In addition, it is preferable that the free magnetic layer be composed of an enhancing layer formed from a CoFe alloy and a soft magnetic layer formed from a NiFe alloy, which are laminated to each other in that order from the bottom, that the enhancing layer be formed in contact with the insulating barrier layer, and that the soft magnetic layer be formed in contact with the first protective layer. Accordingly, the rate of change in resistance (AR/R) can be more effectively improved. Although the rate of change in resistance (ΔR/R) can be improved in the past by insertion of the enhancing layer, in order to further improve the rate of change in resistance (ΔR/R), the composition or the like of the enhancing layer must be appropriately adjusted, and in the case described above, there has been a problem in that the magnetostriction is increased. On the other hand, according to one embodiment, when the first protective layer formed from Pt or Ru is provided on the free magnetic layer without changing the composition of the enhancing layer and/or the structure of the free magnetic layer, while a high rate of change in resistance (ΔR/R) is maintained, the magnetostriction of the free magnetic layer can be effectively decreased.

In addition, a method for manufacturing a tunnel type magnetic sensor comprises the steps of:

(a) forming a fixed magnetic layer and forming a titanium (Ti) layer on the fixed magnetic layer;

(b) oxidizing the Ti layer to form an insulating barrier layer composed of titanium oxide (Ti—O);

(c) forming a free magnetic layer on the insulating barrier layer; and

(d) forming a first protective layer formed from Pt or Ru on the free magnetic layer.

Accordingly, while a high rate of change in resistance (ΔR/R) is maintained, a tunnel type magnetic sensor capable of effectively decreasing the magnetostriction of the free magnetic layer can be appropriately and simply manufactured.

The step (d) is preferably a step of forming a second protective layer composed of tantalum (Ta) on the first protective layer after the first protective layer is formed.

In addition, the film thickness of the first protective layer is preferably formed to be smaller than that of the second protective layer.

In addition, after the step (d), an annealing treatment is preferably performed.

According to the tunnel type magnetic sensor of the present invention, while a high rate of change in resistance (ΔR/R) is maintained as in the past, the magnetostriction λ of the free magnetic layer can be decreased as compared to that obtained in the past.

### BRIEF DESCRIPTION OF THE DRAWINGS

FIG. 1 is a cross-sectional view of a tunnel type magnetic sensor according to one embodiment, taken along a direction parallel to a facing surface facing a recording medium;

FIG. 2 is a view illustrating a step of a method for manufacturing the tunnel type magnetic sensor according to the embodiment (cross-sectional view of the tunnel type magnetic sensor in process taken along a direction parallel to the facing surface facing a recording medium);

FIG. 3 is a view illustrating a subsequent step performed after the step shown in FIG. 2 (cross-sectional view of the tunnel type magnetic sensor in process taken along a direction parallel to the facing surface facing a recording medium);

FIG. 4 is a view illustrating a subsequent step performed after the step shown in FIG. 3 (cross-sectional view of the tunnel type magnetic sensor in process taken along a direction parallel to the facing surface facing a recording medium); and

FIG. 5 is a view illustrating a subsequent step performed after the step shown in FIG. 4 (cross-sectional view of the tunnel type magnetic sensor in process taken along a direction parallel to the facing surface facing a recording medium).

### DESCRIPTION OF THE PREFERRED EMBODIMENTS

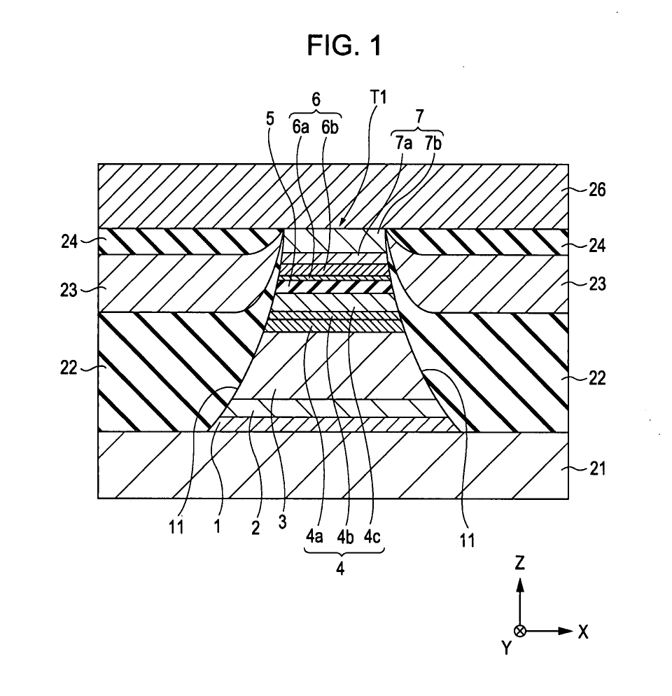

FIG. 1 is a cross-sectional view of a tunnel type magnetic sensor (tunnel type magnetoresistive sensor) according to an embodiment, taken along a direction parallel to a facing surface facing a recording medium.

A tunnel type magnetic sensor is provided at a trailing side end portion or the like of a floating slider provided in a hard disk apparatus and detects a recorded magnetic field from a hard disk or the like. In the figure, an X direction indicates a track width direction, a Y direction indicates a direction of a leak magnetic field from a magnetic recording medium (height direction), and a Z direction indicates a traveling direction of a magnetic recording medium such as a hard disk and a lamination direction of layers forming the tunnel type magnetic sensor.

A layer formed at the lowest position shown in FIG. 1 is a lower shield layer 21 formed, for example, from a NiFe alloy. A laminate T1 is formed on the lower shield layer 21. The tunnel type magnetic sensor described above includes, besides the laminate T1, at two sides thereof in the track width direction (X direction in the figure), lower insulating layers 22, hard bias layers 23, and upper insulating layers 24.

The lowest layer of the laminate T1 is an underlayer 1 formed from a non-magnetic material including at least one element selected from the group consisting of Ta, Hf, Nb, Zr, Ti, Mo, and W. A seed layer 2 is provided on this underlayer 1. The seed layer 2 is formed from NiFeCr or Cr. When the seed layer 2 is formed from NiFeCr, a face-centered cubic (fcc) structure is obtained in which equivalent crystalline planes represented by the {111} planes are preferentially oriented in a direction parallel to the surface of the film. In addition, when the seed layer 2 is formed from Cr, a body-centered cubic (bcc) structure is obtained in which equivalent crystalline planes represented by the {110} planes are preferentially oriented in a direction parallel to the surface of the film. Incidentally, the underlayer 1 may not be formed.

An antiferromagnetic layer 3 formed on the seed layer 2 is preferably formed from an antiferromagnetic material containing an element X (where X is at least one element selected from the group consisting of Pt, Pd, Ir, Rh, Ru, and Os) and Mn.

The X—Mn alloy using a platinum group element has superior corrosion resistance and a high blocking temperature, and in addition, as an antiferromagnetic material, this X—Mn alloy has superior properties such that an exchange coupling magnetic field (Hex) can be increased.

In addition, the antiferromagnetic layer 3 may be formed from an antiferromagnetic material containing the element X, an element X′ (where X′ is at least one element selected from the group consisting of Ne, Ar, Kr, Xe, Be, B, C, N, Mg, Al, Si, P, Ti, V, Cr, Fe, Co, Ni, Cu, Zn, Ga, Ge, Zr, Nb, Mo, Ag, Cd, Sn, Hf, Ta, W, Re, Au, Pb, and rare earth elements), and Mn.

A fixed magnetic layer 4 is formed on the antiferromagnetic layer 3. The fixed magnetic layer 4 has a laminated ferrimagnetic structure composed of a first fixed magnetic layer 4a, a non-magnetic interlayer 4b, and a second fixed magnetic layer 4c laminated to each other in that order from the bottom. The magnetization direction of the first fixed magnetic layer 4a and that of the second fixed magnetic layer 4c are placed in an antiparallel state by an antiferromagnetic exchange coupling magnetic field (PKKY interaction) with the non-magnetic interlayer 4b provided therebetween and an exchange coupling magnetic field at the interface with the antiferromagnetic layer 3. This structure is a so-called laminated ferrimagnetic structure, an by this structure, the magnetization of the fixed magnetic layer 4 can be stabilized, and the exchange coupling magnetic field generated at the interface between the fixed magnetic layer 4 and the antiferromagnetic layer 3 can be apparently increased. In addition, the first fixed magnetic layer 4a and the second fixed magnetic layer 4c are formed, for example, to have a thickness of approximately 12 to 24 Å, and the non-magnetic interlayer 4b is formed to have a thickness of approximately 8 to 10 Å.

The first fixed magnetic layer 4a and the second fixed magnetic layer 4c are formed from a ferromagnetic material such as CoFe, NiFe, or CoFeNi. In addition, the non-magnetic interlayer 4b is formed from a non-magnetic material such as Ru, Rh, Ir, Cr, Re, or Cu.

An insulating barrier layer 5 provided on the fixed magnetic layer 4 is formed from titanium oxide (Ti—O). Although the insulating barrier layer 5 may be formed by sputtering using a target composed of Ti—O, it is preferable that after a Ti layer is formed to have a thickness of about 1 to 10 Å, oxidation be performed to form a Ti—O layer. In this case, although the thickness is increased by oxidation, the thickness of the insulating barrier layer 5 is preferably in the range of approximately 1 to 20 Å. When the thickness of the insulating barrier layer 5 is excessively large, it is not preferable since a tunnel current is not likely to flow.

A free magnetic layer 6 is formed on the insulating barrier layer 5. The free magnetic layer 6 is formed from a soft magnetic layer 6b composed of a magnetic material such as a NiFe alloy and an enhancing layer 6a composed, for example, of a CoFe alloy and provided between the soft magnetic layer 6b and the insulating barrier layer 5. The soft magnetic layer 6b is preferably formed from a magnetic material having superior soft magnetic properties, and the enhancing layer 6a is preferably formed from a magnetic material having a spin polarizability higher than that of the soft magnetic layer 6b. When the soft magnetic layer 6b is formed from a NiFe alloy, in view of the magnetic properties, the content of Ni is preferably in the range of about 81.5 to 100 atomic percent.

By forming the enhancing layer 6a from a CoFe alloy having a high spin polarizability, the rate of change in resistance (ΔR/R) can be improved. In particular, since a CoFe alloy having a high Fe content has a high spin polarizability, the effect of improving the rate of change in resistance (ΔR/R) is significant. Although the Fe content of the CoFe alloy is not particularly limited, it can be set in the range of about 10 to 90 atomic percent.

In addition, when the enhancing layer 6a is formed excessively thick, since the magnetic detection sensitivity of the soft magnetic layer 6b may be adversely influenced and may be degraded in some cases, the thickness of the enhancing layer 6a is formed smaller than that of the soft magnetic layer 6b. The soft magnetic layer 6b is formed, for example, to have a thickness of approximately 40 Å, and the enhancing layer 6a is formed to have a thickness of approximately 10 Å. In addition, the thickness of the enhancing layer 6a is preferably about 6 to 20 Å.

The free magnetic layer 6 may also have a ferrimagnetic structure in which magnetic layers are laminated to each other with at least one non-magnetic interlayer provided therebetween. In addition, a track width Tw is determined by the width dimension of the free magnetic layer 6 in the track width direction (X direction in the figure).

A protective layer 7 is formed on the free magnetic layer 6.

As described above, the laminate T1 is formed on the lower shield layer 21. Two side end surfaces 11 of the laminate T1 in the track width direction (X direction in the figure) are formed to be inclined surfaces so that the width dimension in the track width direction is gradually decreased from the lower side to the upper side.

As shown in FIG. 1, on the lower shield layer 21 extending to the two sides of the laminate T1 and on the two side end surfaces 11 thereof, the lower insulating layers 22 are formed, the hard bias layers 23 are formed on the lower insulating layers 22, and in addition, on the hard bias layers 23, the upper insulating layers 24 are formed.

A bias underlayer (not shown) may be formed between the lower insulating layer 22 and the hard bias layer 23. The bias underlayer is formed, for example, of Cr, W, or Ti.

The insulating layers 22 and 24 are formed from an insulating material such as Al₂O₃ or SiO₂ and insulate the top and the bottom of the hard bias layer 23 so as to suppress current flowing in a direction perpendicular to the interfaces between the individual layers of the laminate T1 from being shunted to the two sides of the laminate T1 in the track width direction. The hard bias layer 23 is formed, for example, of a Co—Pt (cobalt-platinum) alloy or a Co—Cr—Pt (cobalt-chromium-platinum) alloy.

On the laminate T1 and the upper insulating layers 24, the upper shield layer 26 composed of a NiFe alloy or the like is formed.

In the embodiment shown in FIG. 1, the lower shield layer 21 and the upper shield layer 26 function as electrode layers for the laminate T1, and in a direction perpendicular to the film surfaces of the layers forming the laminate T1 (in a direction parallel to the Z direction in the figure), current flows.

The free magnetic layer 6 is magnetized in a direction parallel to the track width direction (X direction in the figure) by a bias magnetic field from the hard bias layers 23. On the other hand, the first fixed magnetic layer 4a and the second fixed magnetic layer 4c, which form the fixed magnetic layer 4, are magnetized in a direction parallel to the height direction (Y direction in the figure). Since the fixed magnetic layer 4 has a laminated ferrimagnetic structure, the first fixed magnetic layer 4a and the second fixed magnetic layer 4c are magnetized antiparallel to each other. Although the magnetization of the fixed magnetic layer 4 is fixed (the magnetization is not varied by an external magnetic field), the magnetization of the free magnetic layer 6 is varied by an external magnetic field.

When the magnetization of the free magnetic layer 6 is varied by an external magnetic field, and when the magnetization of the second fixed magnetic layer 4c and that of the free magnetic layer 6 are antiparallel to each other, a tunnel current becomes unlikely to flow through the insulating barrier layer 5 provided between the second fixed magnetic layer 4c and the free magnetic layer 6, and hence, the resistance is increased to a maximum value. On the other hand, when the magnetization of the second fixed magnetic layer 4c and that of the free magnetic layer 6 are parallel to each other, the tunnel current is most likely to flow, and the resistance is decreased to a minimum value.

With the use of this principle, it is designed that when the magnetization of the free magnetic layer 6 is varied by influence of an external magnetic field, the change in electrical resistance is grasped as the change in voltage, and a leak magnetic field from a recording medium is detected.

In the tunnel type magnetic sensor of this embodiment, the insulating barrier layer 5 is formed from titanium oxide (Ti—O), and on the free magnetic layer 6, the protective layer 7 having a laminated structure is formed which is composed of a first protective layer 7a formed from Pt or Ru and a second protective layer 7b provided thereon and formed from a non-magnetic material other than Pt and Ru.

Accordingly, while a high rate of change in resistance (ΔR/R) is maintained as in a conventional structure, the magnetostriction λ of the free magnetic layer 6 can be decreased as compared to that of the conventional structure.

In this embodiment, the “conventional structure” indicates the structure in which the first protective layer 7a is not provided in the structure of this embodiment. Hereinafter, the “conventional structure” always indicates the structure described above.

Incidentally, aluminum oxide (Al—O) has been used for the insulating barrier layer 5 in many cases. However, as shown in experimental results which will be described later, when the insulating barrier layer 5 is formed from aluminum oxide (Al—O), and Pt or Ru is used for the first protective layer 7a, a decreasing rate of the rate of change in resistance (ΔR/R) based on that of the conventional structure is increased as compared to that obtained when titanium oxide (Ti—O) is used for the insulating barrier layer 5, and in addition, the magnetostriction λ of the free magnetic layer 6 is also not effectively decreased as compare to the case in which titanium oxide (Ti—O) is used for the insulating barrier layer 5.

That is, when aluminum oxide (Al—O) is used for the insulating barrier layer 5, even if the first protective layer 7a formed from Pt or Ru is provided on the free magnetic layer 6, compared to this embodiment in which the insulating barrier layer 5 is formed from titanium oxide (Ti—O), the effect of decreasing the magnetostriction λ of the free magnetic layer 6 while a high rate of change in resistance (ΔR/R) is maintained is not significant, and in particular, it is understood that the rate of change in resistance (ΔR/R) is considerably decreased as compared to that of the conventional structure.

On the other hand, as is the case of this embodiment, when the insulating barrier layer 5 is formed from titanium oxide (Ti—O), and when the first protective layer 7a formed from Pt or Ru is provided on the free magnetic layer 6, as apparent from the experimental results which will be described later, the magnetostriction λ of the free magnetic layer 6 is significantly decreased to a value substantially close to 0 as compared to that of the conventional structure. In addition, although the rate of change in resistance (ΔR/R) is slightly decreased, it is not substantially changed from that of the conventional structure.

In the following experiments, in a tunnel type magnetic sensor using the insulating barrier layer 5 formed from titanium oxide (Ti—O), the magnetostriction λ of the free magnetic layer 6 and the rate of change in resistance (ΔR/R) were measured using various materials besides Pt and Ru for the first protective layer 7a.

For example, when the first protective layer 7a was formed from copper (Cu), although the magnetostriction λ of the free magnetic layer 6 was decreased as compared to that of the conventional structure, the decreasing amount thereof was small as compared to that of this embodiment, and in addition, the rate of change in resistance (ΔR/R) was decreased as compared to that of this embodiment.

In addition, when the first protective layer 7a was formed from titanium (Ti) or iridium-manganese (IrMn), the magnetostriction λ of the free magnetic layer 6 was large as compared to that of the conventional structure. Furthermore, the rate of change in resistance (ΔR/R) was considerably decreased as compared to that of the conventional structure. In addition, when the first protective layer 7a was formed from aluminum (Al), the magnetostriction λ of the free magnetic layer 6 was also large as compared to that of the conventional structure. Furthermore, the rate of change in resistance (ΔR/R) was considerably decreased such that the rate of change in resistance (ΔR/R) could not be appropriately evaluated.

As described above, in this embodiment in which the insulating barrier layer 5 is formed from titanium oxide (Ti—O), and the first protective layer 7a is formed from Pt or Ru, compared to the case of the conventional structure, the magnetostriction λ of the free magnetic layer 6 is considerably decreased; however, when the first protective layer 7a is formed from another metal, such as Cu, Ti, or IrMn, the effect of decreasing the magnetostriction x of the free magnetic layer 6 cannot be obtained, or the effect described above is not significant as compared to that of this embodiment. Accordingly, when the first protective layer 7a is formed from Pt or Ru, the magnetostriction λ of the free magnetic layer 6 can be decreased, and the stability of a reproduction head can be improved.

Furthermore, in this embodiment, although the rate of change in resistance (ΔR/R) is slightly decreased as compared to that of the conventional structure, compared to the case in which the first protective layer 7a is formed from Cu, Ti, or IrMn, the decreasing rate of the rate of change in resistance (ΔR/R) based on the conventional structure is small. In addition, the above decreasing rate based on the conventional structure can be made smaller than that in the case in which the insulating barrier layer 5 is formed from aluminum oxide (Al—O). Hence, when the insulating barrier layer 5 is formed from titanium oxide (Ti—O), and the first protective layer 7a is formed from Pt or Ru, a high rate of change in resistance (ΔR/R) which is substantially equivalent to that of the conventional structure can be obtained, and the detection sensitivity of the reproduction head is hardly influenced.

As described above, when the insulating barrier layer 5 is formed from titanium oxide (Ti—O), and the first protective layer 7a is formed from Pt or Ru, while a high rate of change in resistance (ΔR/R) similar to that of the conventional structure is maintained, the magnetostriction λ of the free magnetic layer 6 can be significantly decreased as compared to that of the conventional structure, and hence a reproduction head having superior properties and superior stability can be obtained.

In the tunnel type magnetic sensor of this embodiment, for example, as shown in FIG. 1, the protective layer 7 is composed of the two layers, that is, the first protective layer 7a and the second protective layer 7b; however, the protective layer 7 is not limited to a two-layered structure and may be formed to have more than two layers. In this case, Pt or Ru is provided in contact with the free magnetic layer 6 as the first protective layer 7a.

For the second protective layer 7b, a metal, such as Ta, Ti, Al, Cu, Cr, Fe, Ni, Mn, Co, or V, an oxide or a nitride thereof, which has been used for a protective layer may be used. However, Ta is preferably used since it is not likely to be oxidized, has a low electrical resistance, and has favorable mechanical protection properties.

In this embodiment, the structure in which the second protective layer 7b is not formed, that is, the structure in which the first protective layer 7a is only formed, is also included; however, since the first protective layer 7a formed from Ru or Pt has a small thickness, such as several tens of angstroms, as described below, when the first protective layer 7a is oxidized, the oxidation may adversely influence on the free magnetic layer 6 in some cases, and in this case, the properties thereof are degraded. Hence, when the second protective layer 7b formed from Ta and having a larger thickness than that of the first protective layer 7a is provided thereon, the influence of the oxidation on the free magnetic layer 6 can be suppressed, and as a result, a tunnel type magnetic sensor having stable properties can be obtained.

The first protective layer 7a can be formed, for example, by sputtering of Pt or Ru on the free magnetic layer 6. The thickness of the first protective layer 7a is preferably in the range of about 2 to 100 Å and more preferably in the range of about 4 to 30 Å. When the thickness of the first protective layer 7a is outside the range described above, a high rate of change in resistance (ΔR/R) cannot be obtained, and in addition, it is believed that the effect of decreasing the magnetostriction λ of the free magnetic layer 6 is also not significant.

The tunnel type magnetic sensor is processed by an annealing treatment in a manufacturing process as described below. The annealing treatment is performed at a temperature of about 240 to 310° C. This annealing treatment is, for example, an annealing treatment in magnetic field which is performed to generate an exchange coupling magnetic field (Hex) between the first fixed magnetic layer 4a forming the fixed magnetic layer 4 and the antiferromagnetic layer 3.

When the temperature of the annealing treatment is less than about 240° C. or even in the range of about 240 to 310° C., and when the annealing time is less than about 4 hours, no counter diffusion of constituent elements occurs at the interface between the first protective layer 7a and the free magnetic layer 6 and at the interface between the first protective layer 7a and the second protective layer 7b, or even if the counter diffusion occurs, the degree thereof is not significant (for example, diffusion does not occur at the entire interface but only intermittently occurs), and it is believed that the state of the interface is practically maintained.

On the other hand, when the temperature of the annealing treatment is more than about 310° C., or the annealing time is about 4 hours or more, counter diffusion of constituent elements occurs at the interface between the first protective layer 7a and the free magnetic layer 6 and at the interface between first protective layer 7a and the second protective layer 7b, and as a result, the interfaces described above disappear; hence, as a result, a concentration gradient is generated in which the Ru concentration or the Pt concentration is gradually decreased from the inside of the first protective layer 7a, such as from the center of the thickness thereof, in a direction toward the interface (toward the lower side in the figure) of the free magnetic layer 6 with the insulating barrier layer 5 and in a direction toward the upper surface (toward the upper side in the figure) of the second protective layer 7b.

From the experimental results (of examples and comparative examples) which will be described below, the influences of the first protective layer 7a formed from Pt or Ru on the free magnetic layer 6 are believed as follows.

In this embodiment in which the first protective layer 7a formed from Pt or Ru is provided, the magnetostriction λ of the free magnetic layer 6 is significantly small as compared to that of the conventional structure. The absolute value of the above magnetostriction λ can be decreased to approximately 0. In addition, in this embodiment, the rate of change in resistance (ΔR/R) substantially equivalent to that of the conventional structure can be obtained.

Accordingly, since being in contact with the free magnetic layer 6, the first protective layer 7a formed from Pt or Ru has some influence on the free magnetic layer 6, in particular, on the crystalline structure of the soft magnetic layer 6b located at the interface with the first protective layer 7a, and hence, it is believed that the effect of decreasing the magnetostriction can be obtained. In addition, it is also believed that part of Pt or Ru in contact with the free magnetic layer 6 is diffused by a heat treatment so that, for example, the crystalline lattice at the interface with the soft magnetic layer 6b is deformed, and that as a result, the crystalline structure of the free magnetic layer 6 is influenced. On the other hand, since the rate of change in resistance (ΔR/R) of this embodiment and that of the conventional structure are not substantially different from each other, it is believed that Pt or Ru of the first protective layer 7a of this embodiment has no influence on the enhancing layer 6a, in particular, on the vicinity of the interface of the enhancing layer 6a with the insulating barrier layer 5. In addition, it is believed that although part of Pt or Ru is diffused to the free magnetic layer 6, in particular, to the soft magnetic layer 6b by the heat treatment, it is not diffused to the enhancing layer 6a.

In order to examine the influence of Pt or Ru on the soft magnetic properties of the free magnetic layer 6, the coercive force (Hc) of the free magnetic layer 6 of this embodiment and that of the conventional structure were measured. The coercive force of the free magnetic layer 6 of this embodiment shows a value substantially equivalent to that of the conventional structure. From the result thus obtained, even when the first protective layer 7a formed from Pt or Ru is provided, or part of Pt or Ru is diffused to the free magnetic layer 6 by the heat treatment, it is believed that the soft magnetic properties of the free magnetic layer 6 are hardly influenced.

In addition, an interlayer coupling magnetic field (Hin) acting on between the free magnetic layer 6 and the fixed magnetic layer 4 of this embodiment and that of the conventional structure were measured. The interlayer coupling magnetic field (Hin) of this embodiment shows a value substantially equivalent to that of the conventional structure. From the result thus obtained, even when the first protective layer 7a formed from Pt or Ru is provided, it is believed that the soft magnetic properties of the free magnetic layer 6 are hardly influenced. In addition, even when part of Pt or Ru is diffused to the free magnetic layer 6 by the heat treatment, it is believed that the soft magnetic properties of the free magnetic layer 6 are hardly influenced. Furthermore, even when Pt or Ru is diffused to the free magnetic layer 6 in contact with the protective layer 7, since the rate of change in resistance (ΔR/R) is not substantially changed, it is believed that Pt or Ru is not diffused to the insulating barrier layer 5 and, in addition, to the fixed magnetic layer 4 in contact with the insulating barrier layer 5.

In addition, when the first protective layer 7a is formed from a relatively heavy metal, such as Pt or Ru, an element forming the second protective layer 7b which is formed from a relatively heavy metal as is the first protective layer 7a is unlikely to be diffused to the free magnetic layer 6.

In this embodiment, the free magnetic layer 6 is preferably has a laminated structure composed of the enhancing layer 6a and the soft magnetic layer 6b. The enhancing layer 6a is formed from a CoFe alloy, has a high spin polarizability as compared to that of the soft magnetic layer 6b, and has an effect of improving the rate of change in resistance (ΔR/R). Accordingly, although the rate of change in resistance (ΔR/R) can also be improved by insertion of the enhancing layer 6a in the conventional structure, in order to decrease the magnetostriction which is increased by the insertion of the enhancing layer 6a, the film thickness, composition and the like must be improved, and by the improvement in magnetostriction, the rate of change in resistance (ΔR/R) may be decreased in some cases; hence, it has been difficult to decrease the magnetostriction while a high rate of change in resistance (ΔR/R) is maintained. On the other hand, in this embodiment, in particular, without changing the composition of the enhancing layer 6a, the structure of the free magnetic layer 6, and the like, when the first protective layer 7a formed from Pt or Ru is provided on the free magnetic layer 6, while a high rate of change in resistance (ΔR/R) is maintained, the magnetostriction λ of the free magnetic layer 6 can be effectively decreased.

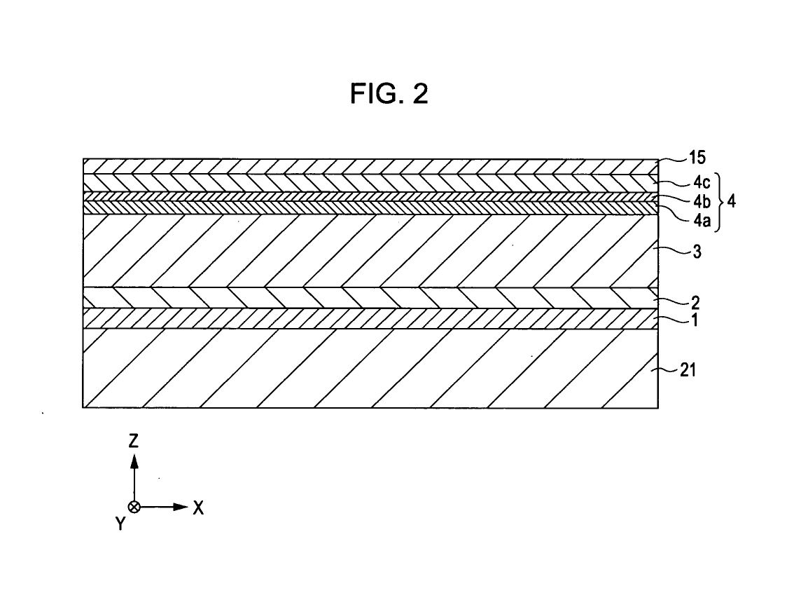

A method for manufacturing the tunnel type magnetic sensor according to this embodiment will be described. FIGS. 2 to 4 are partial cross-sectional views each showing a tunnel type magnetic sensor in process taken along the same direction as that shown in FIG. 1.

In the step shown in FIG. 2, on the lower shield layer 21, the underlayer 1, the shield layer 2, the antiferromagnetic layer 3, the first fixed magnetic layer 4a, the non-magnetic interlayer 4b, and the second fixed magnetic layer 4c are sequentially formed.

Subsequently, on the second fixed magnetic layer 4c, a metal layer 15 is formed by a sputtering method or the like. Since the metal layer 15 is oxidized in a subsequent step, the metal layer 15 is formed so as to have an appropriate thickness as the insulating barrier layer 5 which is formed by the oxidation. In this embodiment, as the metal, Ti is used.

Next, oxygen is supplied into a vacuum chamber. Accordingly, the metal layer 15 described above is oxidized, so that the insulating barrier layer 5 is formed.

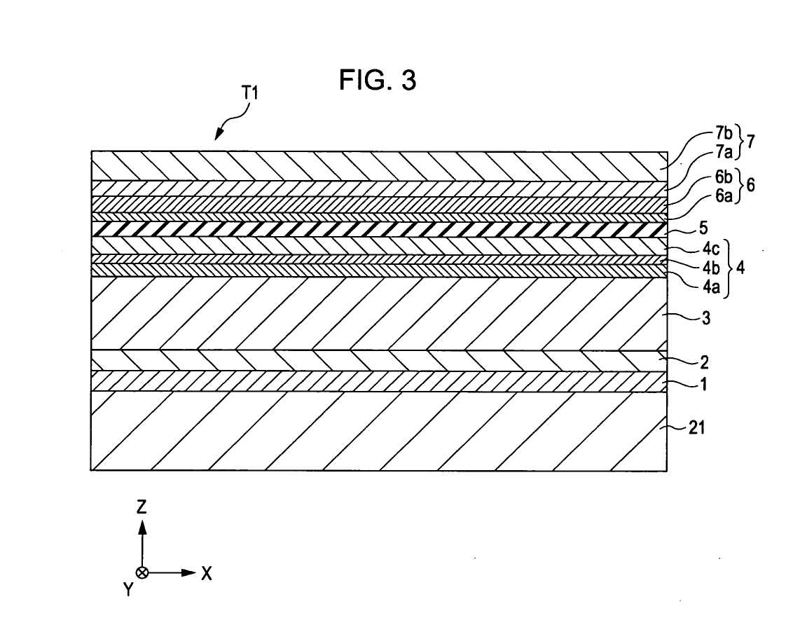

Subsequently, as shown in FIG. 3, on the insulating barrier layer 5, the free magnetic layer 6 composed of the enhancing layer 6a and the soft magnetic layer 6b is formed. Furthermore, on the free magnetic layer 6, the first protective layer 7a formed from Pt or Ru is provided, and in addition, the second protective layer 7b is provided thereon. As a result, the laminate T1 is obtained which is composed of the layers from the underlayer 1 to the protective layer 7 laminated to each other.

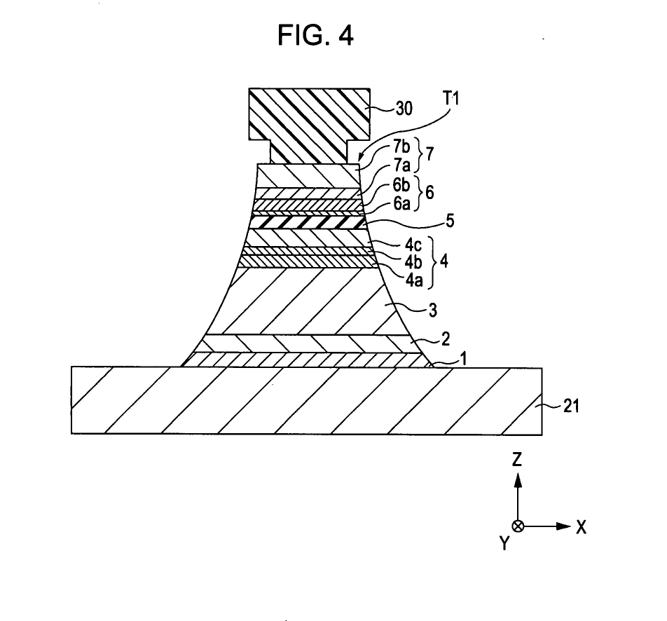

Next, a resist layer 30 for lift-off is formed on the laminate T1, and two side end portions of the laminate T1 in the track width direction (X direction in the figure), which are not covered with the above resist layer 30, are removed by etching or the like (see FIG. 4).

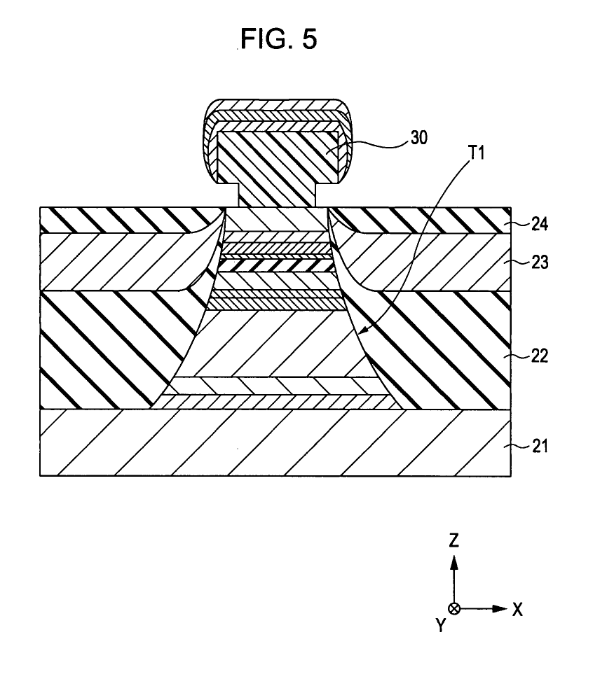

Next, on the two sides of the laminate T1 in the track width direction (X direction in the figure) and on the lower shield layer 21, the lower insulating layers 22, the hard bias layers 23, and the upper insulating layers 24 are laminated in that order from the bottom (see FIG. 5).

Subsequently, the resist layer 30 for lift-off is removed, and the upper shield layer 26 is formed on the laminate T1 and the upper insulating layers 24.

In the method for manufacturing a tunnel type magnetic sensor described above, the annealing treatment is included as described above. A typical annealing treatment is an annealing treatment to generate an exchange coupling magnetic field (Hex) between the antiferromagnetic layer 3 and the first fixed magnetic layer 4a and is performed at a temperature of about 240 to 310° C.

When the temperature of the annealing treatment is less than about 240° C. or even in the range of about 240 to 310° C., and when the annealing time is less than about 4 hours, no counter diffusion of constituent elements occurs at the interface between the first protective layer 7a and the free magnetic layer 6 and at the interface between the first protective layer 7a and the second protective layer 7b, or even if the counter diffusion occurs, the degree thereof is not significant (for example, diffusion does not occur at the entire interface but only intermittently occurs), and it is believed that the state of the interface is practically maintained.

On the other hand, when the temperature of the annealing treatment is more than about 310° C., or the annealing time is about 4 hours or more, counter diffusion of constituent elements occurs at the interface between the first protective layer 7a and the free magnetic layer 6 and at the interface between first protective layer 7a and the second protective layer 7b, and as a result, the interfaces described above disappear; hence, a concentration gradient is generated in which the Ru concentration or the Pt concentration is gradually decreased from the inside of the first protective layer 7a, such as from the center of the thickness thereof, in a direction toward the interface (toward the lower side in the figure) of the free magnetic layer 6 with the insulating barrier layer 5 and in a direction toward the upper surface (toward the upper side in the figure) of the second protective layer 7b.

In addition, when the insulating barrier layer 5 is formed by oxidation of the metal layer 15, as an oxidation method, for example, radical oxidation, ion oxidation, plasma oxidation, or natural oxidation may be mentioned.

As has thus been described, while a high rate of change in resistance (ΔR/R) is maintained as is the tunnel type magnetic sensor of the conventional structure, a tunnel type magnetic sensor can be appropriately and simply manufactured in which the magnetostriction λ of the free magnetic layer 6 is small as compared to that of the conventional structure.

### EXAMPLES

The tunnel type magnetic sensor shown in FIG. 1 was formed.

The underlayer 1 of Ta (about 80 Å); the seed layer 2 of NiFeCr (about 50 Å); the antiferromagnetic layer 3 of IrMn (about 70 Å), the fixed magnetic layer 4 composed of the first fixed magnetic layer 4a of Co_{70 atm %}Fe_{30 atm %} (about 14 Å) the non-magnetic interlayer 4b of Ru (about 9.1 Å), and the second fixed magnetic layer 4c of Co_{90 atm %}Fe_{10 atm %} (about 18 Å); and the metal layer 15 of Ti (about 5.6 Å) were laminated to each other in that order from the bottom. Subsequently, oxidation was performed, so that the metal layer was oxidized to form the insulating barrier layer 5 composed of Ti—O. On the insulating barrier layer 5 thus formed, the free magnetic layer 6 composed of the enhancing layer 6a of Co_{50 atm %}Fe_{50 atm %} (about 10 Å) and the soft magnetic layer 6b of Ni_{86 atm %}Fe_{14 atm %} (about 40 Å), and the protective layer 7 composed of the first protective layer 7a of Pt (about 20 Å) and the second protective layer 7b of Ta (about 180 Å) were laminated to each other in that order, thereby forming the laminate T1.

After the laminate T1 was formed, the annealing treatment was performed at about 270° C. for about 210 minutes (example 1). In addition, in a manner similar to that described above, the laminate T1 was formed using Ru for the first protective layer 7a, followed by the annealing treatment (example 2).

Measurement results of the rate of change in resistance (ΔR/R) and the magnetostriction λ of the free magnetic layer 6 are shown in Table 1. In addition, measurement results of the coercive force (Hc) of the free magnetic layer and the interlayer coupling magnetic field (Hin) are also shown in Table 1.

Results obtained by changing the material for the first protective layer 7a are shown in columns of comparative examples 1 to 5. As the material for the first protective layer 7a, Cu, Ti, IrMn, and Al were used in comparative examples 1, 2, 3, and 4, respectively. The thickness was set to about 20 Å which was the same as that of the first protective layer 7a formed from Pt or Ru used in example 1 or 2, respectively. In addition, in comparative example 5, the conventional structure having no first protective layer was used, and the protective layer 7 was formed only by the second protective layer 7b formed from Ta to have a thickness of about 200 Å. When the first protective layer 7a was formed from Al (comparative example 4), since the rate of change in resistance (ΔR/R) was too low, the evaluation thereof could not be appropriately performed.

TABLE 1

| | First Protective | | ΔR/R | RA | Hc | Hin |
|---|---|---|---|---|---|---|
| | Layer | λ (ppm) | (%) | (Ωμm²) | (Oe) | (Oe) |
| Example 1 | Pt | −0.3 | 21.22 | 3.88 | 4.1 | 14.3 |
| Example 2 | Ru | 0.7 | 20.52 | 3.22 | 3.7 | 13.8 |
| Comparative | Cu | 2.6 | 20.91 | 3.05 | 4.7 | 15.3 |
| Example 1 | | | | | | |
| Comparative | Ti | 5.0 | 15.59 | 1.85 | 4.3 | 20.7 |
| Example 2 | | | | | | |
| Comparative | IrMn | 4.6 | 10.24 | 2.51 | 4.0 | 14.3 |
| Example 3 | | | | | | |
| Comparative | Al | 5.0 | — | — | 4.4 | 27.5 |
| Example 4 | | | | | | |
| Comparative | none | 3.5 | 22.10 | 3.16 | 4.1 | 16.2 |
| Example 5 | | | | | | |

* 10e being approximately equal to 79 A/m

From Table 1, according to the tunnel type magnetic sensor using Pt or Ru for the first protective layer 7a, compared to comparative example 5 having the conventional structure in which the first protective layer is not formed, and in which the protective layer is formed only by the second protective layer, the magnetostriction λ (absolute value) of the free magnetic layer is very small and has a value close to 0. In addition, the rate of change in resistance (ΔR/R) has a high value substantially equivalent to that obtained in comparative example 5.

On the other hand, according to the tunnel type magnetic sensor using Cu for the first protective layer 7a (comparative example 1), compared to comparative example 5, although the rate of change in resistance (ΔR/R) is not substantially changed, the magnetostriction λ of the free magnetic layer is not significantly decreased. In addition, according to the tunnel type magnetic sensors using Ti, IrMn, and Al for the first protective layer 7a, compared to comparative example 5, the magnetostriction λ of the free magnetic layer is large, and in addition, the rate of change in resistance (ΔR/R) is also considerably decreased.

Accordingly, when the first protective layer 7a is formed from Pt or Ru, it is understood that while a high rate of change in resistance (ΔR/R) is maintained, the magnetostriction λ of the free magnetic layer 6 can be significantly decreased.

Furthermore, when the first protective layer 7a is formed from Pt or Ru, compared to comparative example 5 having the conventional structure in which the first protective layer 7a is not provided, it is understood that the coercive force (Hc) of the free magnetic layer and the interlayer coupling magnetic field (Hin) are not substantially changed, and that even when the first protective layer 7a formed from Pt or Ru is provided on the free magnetic layer, the soft magnetic properties of the tunnel type magnetic sensor are not influenced.

Next, the metal layer 15 of the basic film structure used in the above experiment was formed from Al, and Al was then oxidized at about 1 Torr for about 15 minutes, so that a tunnel type magnetic sensor having the insulating barrier layer 5 composed of aluminum oxide was formed.

In the experiment, three tunnel type magnetic sensors, that is, a sensor in which Pt was used for the first protective layer 7a (comparative example 7), a sensor in which Ru was used for the first protective layer 7a (comparative example 8), and a sensor in which the first protective layer was not formed (comparative example 6), were formed, and the rate of change in resistance (ΔR/R) of each tunnel type magnetic sensor and the magnetostriction λ of the free magnetic layer 6 were measured.

TABLE 2

| | | ΔR/R (%) | | λ (ppm) | |
|---|---|---|---|---|---|
| | | Al—O | Ti—O | Al—O | Ti—O |
| First | None | 27.15 | 22.10 (comparative | 3.6 (comparative | 3.5 (comparative |
| Protective | | (comparative | example 5) | example 6) | example 5) |
| Layer | | example 6) | | | |
| | Pt | 22.31 | 21.22 (example 1) | −1.4 (comparative | −0.3 (example 1) |
| | | (comparative | (▴3.9%) | example 7) | |
| | | example 7) | | | |
| | | (▴17.8%) | | | |
| | Ru | 24.20 | 20.52 (example 2) | 1.2 (comparative | 0.7 (example 2) |
| | | (comparative | (▴7.1%) | example 8) | |
| | | example 8) | | | |
| | | (▴10.9%) | | | |

As apparent from the column of the rate of change in resistance (ΔR/R) shown in Table 2, it is found that as for the decreasing rate of the rate of change in resistance (ΔR/R) based on that of comparative example 6 in which the first protective layer 7a is not formed, comparative examples 7 and 8 both show a very large value. In both comparative examples 7 and 8, the insulating barrier layer 5 formed from aluminum oxide (Al—O) is used, and the protective layers 7a formed from Pt and Ru are used in comparative examples 7 and 8, respectively. The “decreasing rate” can be calculated by the following equation when comparative example 7 is taken as an example.

Decreasing rate=[(rate of change in resistance (ΔR/R) of comparative example 6−rate of change in resistance (ΔR/R) of comparative example 7)/rate of change in resistance (ΔR/R) of comparative example 6]×100(%)

On the other hand, with respect to comparative example 5 (the same as comparative example 5 shown in Table 1) in which the first protective layer 7a is not formed, it is also found that although the rate of change in resistance (ΔR/R) of example 1 (the same as example 1 shown in Table 1) in which the insulating barrier layer 5 is formed from titanium oxide (Ti—O) and the first protective layer 7a is formed from Pt and that of example 2 (the same as example 2 shown in Table 1) in which the insulating barrier layer 5 is formed from titanium oxide (Ti—O) and the first protective layer 7a is formed from Ru are both decreased, the decreasing rates thereof can be sufficiently made smaller than that of comparative examples 7 and 8, respectively.

In addition, as apparent from the column of the magnetostriction λ of the free magnetic layer 6 shown in Table 2, it is found that although the magnetostrictions λ of the free magnetic layers 6 of comparative examples 7 and 8 in which the insulating barrier layer 5 is formed from aluminum oxide (Al—O) can be decreased as compared to that of comparative example 6, the magnetostrictions of examples 1 and 2 in which the insulating barrier layer 5 is formed from titanium oxide (Ti—O) can be decreased to approximately 0. In particular, since the magnetostrictions λ of the free magnetic layers 6 of comparative examples 5 and 6 in which the first protective layer 7a is not provided are approximately equivalent to each other, it is found that the effect of decreasing the magnetostriction of examples 1 and 2 in which the insulating barrier layer 5 is formed from titanium oxide (Ti—O) is significant as compared to that of comparative examples 7 and 8 in which the insulating barrier layer 5 is formed from aluminum oxide (Al—O).

Accordingly, the effect of maintaining a high rate of change in resistance (ΔR/R) and the effect of decreasing the magnetostriction of the free magnetic layer 6, which are obtained when the first protective layer 7a formed from Pt or Ru is provided on the free magnetic layer 6, are effective when the insulating barrier layer 5 is formed from titanium oxide (Ti—O).

What is claimed is:

1. A tunnel type magnetic sensor comprising:
a fixed magnetic layer in which the magnetization direction is fixed in one direction;
an insulating barrier layer; and
a free magnetic layer in which the magnetization direction is varied by an external magnetic field, the layers being laminated to each other in that order from the bottom,
wherein the insulating barrier layer comprises titanium oxide (Ti—O), and
on the free magnetic layer, a first protective layer comprising one of platinum (Pt) and ruthenium (Ru) is formed.

2. The tunnel type magnetic sensor according to claim 1, wherein counter diffusion of constituent elements occurs at the interface between the first protective layer and the free magnetic layer, and a concentration gradient is formed in which the platinum concentration or the ruthenium concentration is gradually decreased from the inside of the first protective layer in a direction toward the interface of the free magnetic layer with the insulating barrier layer.

3. The tunnel type magnetic sensor according to claim 1,
wherein on the first protective layer, a second protective layer comprising tantalum (Ta) is formed.

4. The tunnel type magnetic sensor according to claim 3,
wherein counter diffusion of constituent elements occurs at the interface between the first protective layer and the second protective layer, and a concentration gradient is formed in which the platinum concentration or the ruthenium concentration is gradually decreased from the inside of the first protective layer in a direction toward an upper surface of the second protective layer.

5. The tunnel type magnetic sensor according to claim 3,
wherein the first protective layer has a film thickness smaller than that of the second protective layer.

6. The tunnel type magnetic sensor according to claim 1,
wherein the free magnetic layer comprises an enhancing layer formed from a CoFe alloy and a soft magnetic layer formed from a NiFe alloy, which are laminated to each other in that order from the bottom, the enhancing layer is in contact with the insulating barrier layer, and the soft magnetic layer is in contact with the first protective layer.

7. A method for manufacturing a tunnel type magnetic sensor, the method comprising:
(a) forming a fixed magnetic layer and forming a titanium (Ti) layer on the fixed magnetic layer;
(b) oxidizing the Ti layer to form an insulating barrier layer comprising titanium oxide (Ti—O);
(c) forming a free magnetic layer on the insulating barrier layer; and
(d) forming a first protective layer comprising one of Pt or Ru on the free magnetic layer.

8. The method for manufacturing a tunnel type magnetic sensor according to claim 7,
wherein the step (d) comprises forming a second protective layer comprising tantalum (Ta) on the first protective layer after the first protective layer is formed.

9. The method for manufacturing a tunnel type magnetic sensor according to claim 8,
wherein the film thickness of the first protective layer is smaller than that of the second protective layer.

10. The method for manufacturing a tunnel type magnetic sensor according to claim 7,
wherein after the step (d), an annealing treatment is performed.

11. An electronic device comprising:
a tunnel type magnetic sensor, the tunnel type magnetic sensor comprising a fixed magnetic layer in which the magnetization direction is fixed in one direction, an insulating barrier layer, and a free magnetic layer in which the magnetization direction is varied by an external magnetic field, the layers being laminated to each other in that order from the bottom,
wherein the insulating barrier layer comprises titanium oxide (Ti—O), and
on the free magnetic layer, a first protective layer comprising one of platinum (Pt) and ruthenium (Ru) is formed.

12. The electronic device according to claim 11,
wherein counter diffusion of constituent elements occurs at the interface between the first protective layer and the free magnetic layer, and a concentration gradient is formed in which the platinum concentration or the ruthenium concentration is gradually decreased from the inside of the first protective layer in a direction toward the interface of the free magnetic layer with the insulating barrier layer.

13. The electronic device according to claim 11,
wherein on the first protective layer, a second protective layer comprising tantalum (Ta) is formed.

14. The electronic device according to claim 13,
wherein counter diffusion of constituent elements occurs at the interface between the first protective layer and the second protective layer, and a concentration gradient is formed in which the platinum concentration or the ruthenium concentration is gradually decreased from the inside of the first protective layer in a direction toward an upper surface of the second protective layer.

15. The electronic device according to claim 13,
wherein the first protective layer has a film thickness smaller than that of the second protective layer.

16. The electronic device according to claim 11,
wherein the free magnetic layer comprises an enhancing layer formed from a CoFe alloy and a soft magnetic layer formed from a NiFe alloy, which are laminated to each other in that order from the bottom, the enhancing layer is in contact with the insulating barrier layer, and the soft magnetic layer is in contact with the first protective layer.
